(19) United States
(12) Patent Application Publication
(10) Pub. No.: US 2007/0046576 A1
(43) Pub. Date: Mar. 1, 2007

(54) PLASMA DISPLAY APPARATUS AND METHOD OF DRIVING THE SAME

(75) Inventors: Dongki Paik, Seoul (KR); Jongrae Lim, Gyeonggi-do (KR); Tae Heon Kim, Seoul (KR); Wootae Kim, Gyeonggi-do (KR); Sung Chun Choi, Gyeonggi-do (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/466,655

(22) Filed: Aug. 23, 2006

(30) Foreign Application Priority Data
Aug. 23, 2005 (KR) 10-2005-0077029

(51) Int. Cl. G09G 3/28

(52) U.S. Cl. 345/67

(57) ABSTRACT

A plasma display apparatus and a method of driving the same are disclosed. In the method of driving the plasma display apparatus, a first pulse falling from a reference voltage level is supplied to a sustain electrode prior to a reset period. A voltage of a scan electrode is maintained at the reference voltage level during the supplying of the first pulse to the sustain electrode. A reset pulse is supplied to at least one of the scan electrode and the sustain electrode during the reset period.

This Nonprovisional application claims priority under 35 U.S.C. § 119(a) on Patent Application No. 10-2005-0077029 filed in Korea on Aug. 23, 2005 the entire contents of which are hereby incorporated by reference.

### BACKGROUND OF THE INVENTION

1. Field of the Invention

This document relates to a display apparatus, and more particularly to, a plasma display apparatus and a method of driving the same.

2. Description of the Background Art

A plasma display apparatus comprises a plasma display panel for displaying an image and a driver for driving the plasma display panel. The driver is attached on a rear surface of the plasma display panel.

In the plasma display panel, barrier ribs disposed between a front substrate and a rear substrate form unit discharge cell or discharge cells. Each of the discharge cells is filled with a main discharge gas such as neon (Ne), helium (He) and a gas mixture of Ne and He, and an inert gas containing a small amount of xenon (Xe). The plurality of discharge cells form one pixel. For example, a red (R) discharge cell, a green (G) discharge cell and a blue (B) discharge cell form one pixel.

When it is discharged by a high frequency voltage, the inert gas generates vacuum ultra-violet rays, which thereby cause phosphors formed between the barrier ribs to emit light, thus displaying an image.

The plasma display panel comprises a plurality of electrodes, for example, a scan electrode, a sustain electrode and an address electrode. Drivers for supplying a driving voltage to each of the scan, sustain and address electrodes of the plasma display panel are connected to the scan electrode, the sustain electrode and the address electrode, respectively.

When driving the plasma display panel, the drivers supply a reset pulse in a reset period, a scan pulse in an address period, and a sustain pulse in a sustain period to the scan, sustain and address electrodes of the plasma display panel such that the image is displayed. Since the plasma display panel can be manufactured to be thin and light, it has attracted attention as a next generation display device.

When driving the plasma display apparatus by supplying the pulses to the electrodes, various factors may cause a reduction in driving reliability of the plasma display apparatus.

For example, a driving pulse such as the reset pulse, the scan pulse supplied to the electrodes of the plasma display panel generates a discharge, thereby displaying an image. The driving pulse affects greatly the discharge. In other words, a state of wall charges depends on various conditions of the driving pulse such that an erroneous discharge may occur. Therefore, research for optimizing the driving conditions of the plasma display apparatus has been continued.

### SUMMARY OF THE INVENTION

Accordingly, an object of the present invention is to solve at least the problems and disadvantages of the background art.

In an aspect, there is provided a method of driving a plasma display apparatus comprising a scan electrode and a sustain electrode, comprising supplying a first pulse gradually falling from a reference voltage level to the sustain electrode prior to a reset period.

In another aspect, there is provided a method of driving a plasma display apparatus comprising a scan electrode and a sustain electrode, comprising supplying a first pulse falling from a reference voltage level to the sustain electrode prior to a reset period, maintaining a voltage of the scan electrode at the reference voltage level during the supplying of the first pulse to the sustain electrode, and supplying a reset pulse to at least one of the scan electrode and the sustain electrode during the reset period.

In still another aspect, there is provided a plasma display apparatus comprising a plasma display panel comprising a scan electrode and a sustain electrode, and a driver for supplying a first pulse gradually falling from a reference voltage level to the sustain electrode prior to a reset period.

### BRIEF DESCRIPTION OF THE DRAWINGS

The embodiment of the invention will be described in detail with reference to the following drawings in which like numerals refer to like elements.

FIG. 1 illustrates a plasma display apparatus according to an embodiment of the present invention;

FIG. 2 illustrates the structure of a plasma display panel of the plasma display apparatus according to the embodiment of the present invention;

FIG. 3 illustrates a method for representing gray scale of an image in the plasma display apparatus according to the embodiment of the present invention;

FIG. 4 illustrates a driving waveform generated by the plasma display apparatus according to the embodiment of the present invention; and

FIG. 5 illustrates another driving waveform generated by the plasma display apparatus according to the embodiment of the present invention.

### DETAILED DESCRIPTION OF PREFERRED EMBODIMENTS

Preferred embodiments of the present invention will be described in a more detailed manner with reference to the drawings.

A method of driving a plasma display apparatus comprising a scan electrode and a sustain electrode, comprises supplying a first pulse gradually falling from a reference voltage level to the sustain electrode prior to a reset period.

A lowest voltage level of the first pulse may be substantially equal to a scan voltage.

A lowest voltage level of the first pulse may be substantially equal to a set-down voltage.

A duration of time for the supplying of the first pulse may range from 50 um to 150 um.

The first pulse may fall from a ground level voltage to a scan voltage.

A slope of the first pulse may be substantially equal to a slope of a set-down pulse of a reset pulse.

The supplying of the reference voltage level to the scan electrode may occur during the supplying of the first pulse.

A method of driving a plasma display apparatus comprising a scan electrode and a sustain electrode, comprises supplying a first pulse falling from a reference voltage level to the sustain electrode prior to a reset period, maintaining a voltage of the scan electrode at the reference voltage level during the supplying of the first pulse to the sustain electrode, and supplying a reset pulse to at least one of the scan electrode and the sustain electrode during the reset period.

The reset pulse may comprise a setup pulse and a set-down pulse.

A voltage difference between the scan electrode and the sustain electrode may generate a discharge during the reset period

After supplying the setup pulse to the scan electrode during the reset period, the set-down pulse may be supplied to the scan electrode and a voltage of the sustain electrode may be maintained at the reference voltage level.

A voltage difference between the scan electrode and an address electrode formed to intersect the scan electrode may generate a discharge during the reset period.

After supplying the setup pulse to the scan electrode and the sustain electrode during the reset period, the set-down pulse may be supplied to the scan electrode and the sustain electrode during the reset period.

A duration of time for the supplying of the first pulse may range from 50 um to 150 um.

A plasma display apparatus comprises a plasma display panel comprising a scan electrode and a sustain electrode, and a driver for supplying a first pulse gradually falling from a reference voltage level to the sustain electrode prior to a reset period.

A lowest voltage level of the first pulse may be substantially equal to a scan voltage or a set-down voltage.

A duration of time for the supplying of the first pulse may range from 50 um to 150 um.

The first pulse may fall from a ground level voltage to a scan voltage.

A slope of the first pulse may be substantially equal to a slope of a set-down pulse of a reset pulse.

The supplying of the reference voltage level to the scan electrode may occur during the supplying of the first pulse.

Hereinafter, exemplary embodiments of the present invention will be described in detail with reference to the attached drawings.

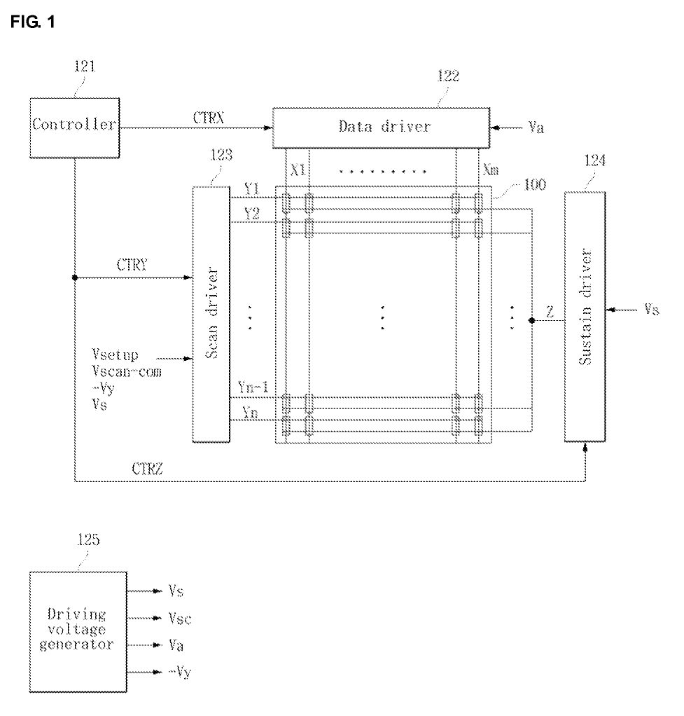

FIG. 1 illustrates a plasma display apparatus according to an embodiment of the present invention.

The plasma display apparatus according to the embodiment of the present invention comprises a plasma display panel 100, on which an image is displayed by processing image data input from the outside, a data driver 122, a scan driver 123, a sustain driver 124, a controller 121 and a driving voltage generator 125. The data driver 122 supplies data to address electrodes X1 to Xm formed on the plasma display panel 100. The scan driver 123 drives scan electrodes Y1 to Yn formed on the plasma display panel 100. The sustain driver 124 drives sustain electrodes Z, which is a common electrode, formed on the plasma display panel 100. The controller 121 controls the data driver 122, the scan driver 123 and the sustain driver 124. The driving voltage generator 125 supplies a necessary driving voltage to each of the drivers 122, 123 and 124.

A front substrate (not shown) and a rear substrate (not shown) of the plasma display panel 100 are coalesced with each other at a given distance. On the front substrate, a plurality of electrodes, for example, the scan electrodes Y1 to Yn and the sustain electrodes Z are formed in pairs. On the rear substrate, the address electrodes X1 to Xm are formed to intersect the scan electrodes Y1 to Yn and the sustain electrodes Z.

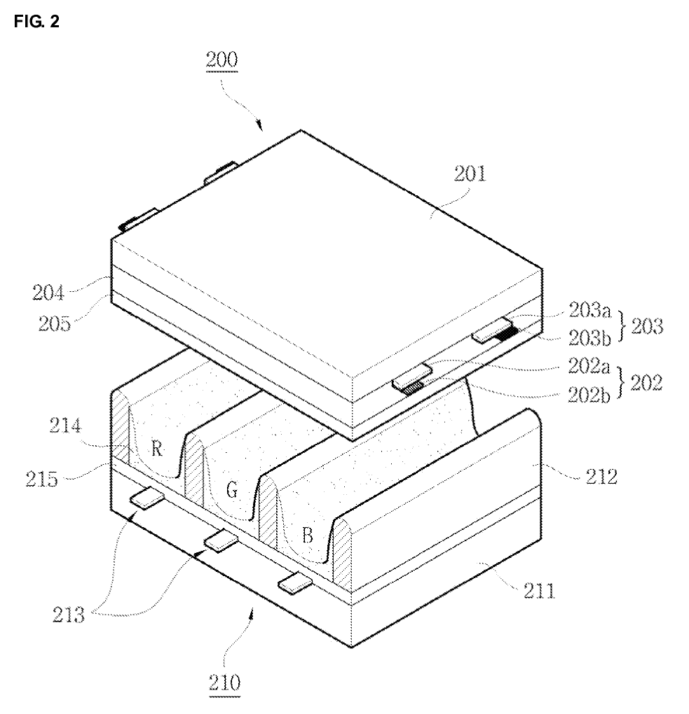

The structure of a plasma display panel of the plasma display apparatus according to the embodiment of the present invention is illustrated in FIG. 2.

As illustrated in FIG. 2, the plasma display panel 100 comprises a front panel 200 and a rear panel 210 which are coupled in parallel to oppose to each other at a given distance therebetween. The front panel 200 comprises a front substrate 201 which is a display surface. The rear panel 210 comprises a rear substrate 211 constituting a rear surface. A plurality of scan electrodes 202 and a plurality of sustain electrodes 203 are formed in pairs on the front substrate 201, on which an image is displayed, to form a plurality of maintenance electrode pairs. A plurality of address electrodes 213 are arranged on the rear substrate 211 to intersect with the plurality of maintenance electrode pairs.

The scan electrode 202 and the sustain electrode 203 each comprise transparent electrodes 202a and 203a made of transparent indium-tin-oxide (ITO) material and bus electrodes 202b and 203b made of a metal material. The scan electrode 202 and the sustain electrode 203 generate a mutual discharge therebetween in one discharge cell and maintain light-emissions of discharge cells. The scan electrode 202 and the sustain electrode 203 each may comprise either the transparent electrodes 202a and 203a or the bus electrodes 202b and 203b. The scan electrode 202 and the sustain electrode 203 are covered with one or more upper dielectric layers 204 to limit a discharge current and to provide insulation between the maintenance electrode pairs. A protective layer 205 with a deposit of MgO is formed on an upper surface of the upper dielectric layer 204 to facilitate discharge conditions.

A plurality of stripe-type (or well-type) barrier ribs 212 are formed in parallel on the rear substrate 211 of the rear panel 210 to form a plurality of discharge spaces, i.e., a plurality of discharge cells). The plurality of address electrodes 213 for performing an address discharge to generate vacuum ultraviolet rays are arranged in parallel to the barrier ribs 212. An upper surface of the rear substrate 211 is coated with Red (R), green (G) and blue (B) phosphors 214 for emitting visible light for an image display when an address discharge is performed. A lower dielectric layer 215 is formed between the address electrodes 213 and the phosphors 214 to protect the address electrodes 213.

The front panel 200 and the rear panel 210 thus formed are coalesced by a sealing process such that the plasma display panel is completed. The drivers for driving the scan electrode 202, the sustain electrode 203 and the address electrode 213 are adhered to the plasma display panel to complete the plasma display apparatus.

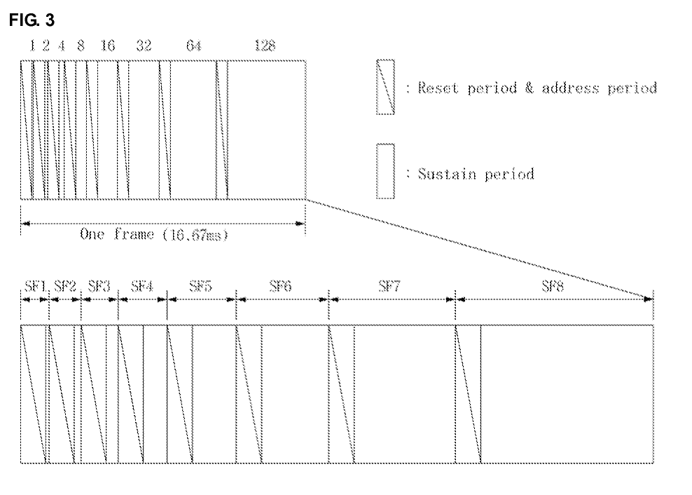

FIG. 3 illustrates a method for representing gray scale of an image in the plasma display apparatus according to the embodiment of the present invention.

As illustrated in FIG. 3, the plasma display apparatus is driven by dividing one frame into a plurality of subfields, so that the image is displayed on the plasma display panel. Each of the subfields comprises a reset period for initializing all cells, an address period for selecting cells to be discharged, and a sustain period for representing gray scale of the image depending on the number of discharge times.

For example, in a case of displaying an image with 256-level gray scale, a frame period (16.67 ms) corresponding to 1/60 second is divided into eight subfields SF1 to SF8. The eight subfields SF1 to SF8 each comprise a reset period, an address period, and a sustain period. The duration of the reset period in a subfield equals to the durations of the reset periods in the remaining subfields. The duration of the address period in a subfield equals to the durations of the address periods in the remaining subfields. The duration of the sustain period and the number of sustain signals supplied in the sustain period increase in a ratio of 2ⁿ (n=0, 1, 2, 3, 4, 5, 6, 7) in each of the subfields.

Below, the description of the plasma display apparatus of FIG. 1 succeeds.

The plasma display apparatus of FIG. 1 according to the embodiment of the present invention comprises the plasma display panel 100, the drivers 122, 123 and 124, the controller 121 and the driving voltage generator 125.

The data driver 122 receives data mapped for each subfield by a subfield mapping circuit (not shown) after being inverse-gamma corrected and error-diffused through an inverse gamma correction circuit (not shown) and an error diffusion circuit (not shown), or the like. The data driver 122 samples and latches the mapped data in response to a timing control signal CTRX supplied from the controller 121, and then a voltage of a data pulse in accordance with the data to the address electrodes X1 to Xm.

Under the control of the controller 121, the scan driver 123 supplies a reset pulse to the scan electrodes Y1 to Yn during a reset period, thereby initializing the discharge cells corresponding to the whole screen. More specifically, after the scan driver 123 supplies the reset pulse to the scan electrodes Y1 to Yn, the scan driver 123 supplies a scan reference voltage Vsc and a voltage of a scan pulse falling from the scan reference voltage Vsc to a negative voltage level to the scan electrodes Y1 to Yn during an address period, thereby scanning the scan electrode lines.

The scan driver 123 supplies a sustain pulse to the scan electrodes Y1 to Yn during a sustain period such that a sustain discharge occurs within the discharge cells selected during the address period.

Under the control of the controller 121, the sustain driver 124 supplies a sustain pulse to the sustain electrodes Z during the sustain period. During the sustain period, the scan driver 123 and the sustain driver 124 alternately operate.

The sustain driver 124 may supply a first pulse gradually falling from a reference voltage level to the sustain electrodes Z prior to the reset period.

A lowest voltage level of the first pulse may be substantially equal to a voltage level of the scan pulse or a set-down voltage of the reset pulse. Further, the sustain driver 124 may supply a first pulse falling from a ground level voltage to a scan voltage to the sustain electrodes Z prior to the reset period. A slope of the first pulse may be equal to a slope of a set-down pulse of the reset pulse. The sustain driver 124 may supply the first pulse for a duration of time ranging from 50 um to 150 um.

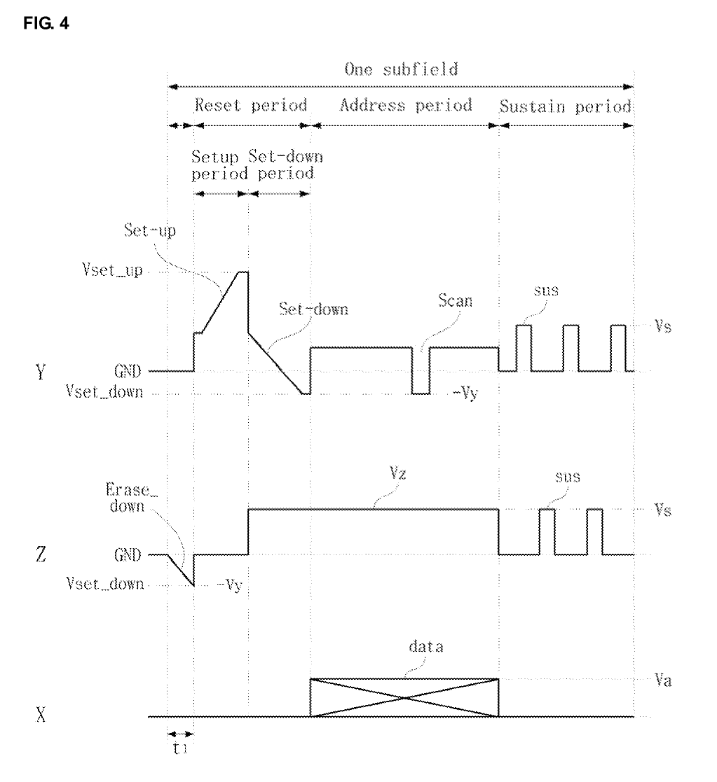

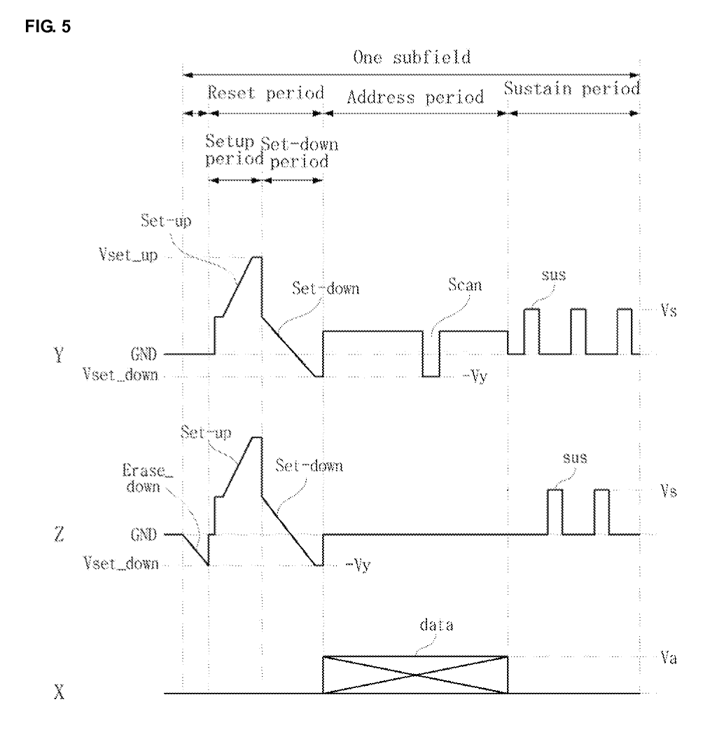

During the supplying of the first pulse to the sustain electrodes Z, the scan driver 123 may supply a reference voltage level to the scan electrodes Y1 to Yn. The first pulse will be described in detail with reference to FIGS. 4 and 5.

The controller 121 receives a vertical/horizontal synchronization signal and a clock signal, and generates timing control signals CTRX, CTRY and CTRZ for controlling the operation timing and synchronization of each of the drivers 122, 123 and 124. The controller 121 supplies the timing control signals CTRX, CTRY and CTRZ to the corresponding drivers 122, 123 and 124 to control each of the drivers 122, 123 and 124. The data control signal CTRX includes a sampling clock for sampling data, a latch control signal, and a switch control signal for controlling the on/off time of an energy recovery circuit and a driving switch element.

The scan control signal CTRY includes a switch control signal for controlling the on/off time of the energy recovery circuit and the driving switch element inside the scan driver 123. The sustain control signal CTRZ includes a switch control signal for controlling the on/off time of the energy recovery circuit and the driving switch element inside the sustain driver 124.

The driving voltage generator 125 generates the driving voltages necessary to each of the drivers 122, 123 and 124, for example, a sustain voltage Vs, a scan reference voltage Vsc, a data voltage Va, a scan voltage -Vy. These driving voltages may vary in accordance with the composition of the discharge gas or the structure of the discharge cell.

The following is a detailed description of a driving waveform generated by the plasma display apparatus according to the embodiment of the present invention, with reference to FIG. 4.

As illustrated in FIG. 4, the plasma display apparatus is driven by dividing each of subfields into a reset period for initializing all cells, an address period for selecting cells to be discharged, and a sustain period for discharge maintenance of the selected cells.

Prior to the reset period, a first pulse (Erase_down) gradually falling from a reference voltage level is supplied to the sustain electrode Z, thereby erasing wall charges remaining inside the cells of the whole screen. In other words, the wall charges of all the discharge cells remain uniform prior to the reset period such that a reset discharge occurs efficiently during the reset period and accuracy of the reset discharge is improved. The reference voltage level may be equal to a ground level voltage GND.

A lowest voltage level of the first pulse (Erase_down) may be substantially equal to the scan voltage -Vy, thereby stabilizing a discharge. For example, the first pulse (Erase_down) may fall from the ground level voltage GND to the scan voltage -Vy. A duration of time t1 for the supplying of the first pulse may range from 50 um to 150 um.

A reference voltage (i.e., a ground level voltage) is supplied to the scan electrode Y during the supplying of the first pulse (Erase_down) to the sustain electrode Z, thereby erasing more efficiently the wall charges inside the discharge cell.

During the reset period, a voltage difference between the scan electrode Y and the sustain electrode Z occurs such that a surface discharge type of a reset discharge occurs. For example, the reset pulse including a setup pulse (Set-up) and a set-down pulse (Set-down) is supplied to all the scan electrodes Y during the reset period. More specifically, during a setup period of the reset period, a voltage Vset_up of the setup pulse (Set-up) is simultaneously supplied to all the scan electrodes Y and a voltage of the sustain electrodes Z is maintained at a given voltage level, thereby generating the voltage difference between the scan electrodes Y and the sustain electrodes Z. This results in the generation of a weak dark discharge within the discharge cells of the whole screen. Since positive charges are accumulated on the sustain electrode Z due to the first pulse (Erase_down) supplied prior to the reset period, the surface discharge type of the reset discharge occurs more efficiently. Accordingly, the reset discharge occurs accurately such that the wall charges of the discharge cell remain in an optimum state.

During a set-down period of the reset period, the set-down pulse (Set-down), which falls from a positive voltage lower than a peak voltage of the setup pulse (Set-up) to a given voltage level, is supplied to the scan electrodes Y. This results in generating a weak erase discharge inside the discharge cells and erasing the wall charges excessively accumulated on the scan electrodes Y. Furthermore, the wall charges remain uniform inside the cells to the extent that the address discharge can be stably performed.

During the address period, a scan pulse (Scan) of a negative polarity is sequentially supplied to the scan electrodes Y and, at the same time, a data pulse (data) of a positive polarity is selectively supplied to the address electrodes X in synchronization with the scan pulse (Scan). As the voltage difference between the scan pulse (Scan) and the data pulse (data) is added to the wall voltages generated during the reset period, the address discharge is generated within the discharge cells to which the data pulse is supplied. Wall charges are formed inside the cells selected by performing the address discharge such that when a sustain voltage Vs is supplied a discharge occurs. A positive voltage Vz is supplied to the sustain electrode Z during at least one of the set-down period and the address period so that an erroneous discharge does not occur between the sustain electrode Z and the scan electrode Y by reducing the voltage difference between the sustain electrode Z and the scan electrode Y.

During the sustain period, a sustain pulse (sus) is alternately supplied to the scan electrode Y and the sustain electrode Z. As the wall voltage within the cells selected by performing the address discharge is added to the sustain pulse (sus), every time the sustain pulse (sus) is applied, a sustain discharge, i.e., a display discharge occurs in the cells selected during the address period.

FIG. 5 illustrates another driving waveform generated by the plasma display apparatus according to the embodiment of the present invention.

As illustrated in FIG. 5, the plasma display apparatus is driven by dividing each of subfields into a reset period for initializing all cells, an address period for selecting cells to be discharged, and a sustain period for discharge maintenance of the selected cells.

Prior to the reset period, a first pulse (Erase_down) gradually falling from a reference voltage level is supplied to the sustain electrode Z, thereby erasing wall charges remaining inside the cells of the whole screen. In other words, the wall charges of all the discharge cells remain uniform prior to the reset period such that a reset discharge occurs efficiently during the reset period and accuracy of the reset discharge is improved. The reference voltage level may be equal to a ground level voltage GND.

A lowest voltage level of the first pulse (Erase_down) may be substantially equal to the scan voltage -Vy, thereby stabilizing a discharge. For example, the first pulse (Erase_down) may fall from the ground level voltage GND to the scan voltage -Vy. A slope of the first pulse (Erase_down) may be substantially equal to a slope of a set-down pulse (Set-down) of a reset pulse, thereby simplifying a driving operation of the plasma display apparatus.

A reference voltage (i.e., a ground level voltage) is supplied to the scan electrode Y during the supplying of the first pulse (Erase_down) to the sustain electrode Z, thereby erasing more efficiently the wall charges inside the discharge cell.

During the reset period, a voltage difference between the scan electrode Y and the address electrode X occurs such that an opposite discharge type of a reset discharge occurs. For example, the reset pulse including a setup pulse (Set-up) and a set-down pulse (Set-down) is supplied to the scan electrodes Y and the sustain electrodes Z during the reset period. More specifically, during a setup period of the reset period, a voltage Vset_up of the setup pulse (Set-up) is simultaneously supplied to the scan electrodes Y and the sustain electrodes Z, thereby generating the voltage difference between the scan electrodes Y and the address electrodes X. This results in the generation of a weak dark discharge inside the discharge cells of the whole screen.

During a set-down period of the reset period, the set-down pulse (Set-down), which falls from a positive voltage lower than a peak voltage of the setup pulse (Set-up) to a given voltage level, is supplied to the scan electrodes Y and the sustain electrodes Z. This results in generating a weak erase discharge inside the discharge cells and erasing the wall charges excessively accumulated on the scan electrodes Y. Furthermore, the wall charges remain uniform inside the cells to the extent that the address discharge can be stably performed.

During the address period, a scan pulse (Scan) of a negative polarity is sequentially supplied to the scan electrodes Y and, at the same time, a data pulse (data) of a positive polarity is selectively supplied to the address electrodes X in synchronization with the scan pulse (Scan). As the voltage difference between the scan pulse (Scan) and the data pulse (data) is added to the wall voltages generated during the reset period, the address discharge is generated within the discharge cells to which the data pulse is supplied. Wall charges are formed inside the cells selected by performing the address discharge such that when a sustain voltage Vs is supplied a discharge occurs. A voltage of the sustain electrodes Z is maintained at a given voltage level, for example, the reference voltage level.

During the sustain period, a sustain pulse (sus) is alternately supplied to the scan electrode Y and the sustain electrode Z. As the wall voltage within the cells selected by performing the address discharge is added to the sustain pulse (sus), every time the sustain pulse (sus) is applied, a sustain discharge, i.e., a display discharge occurs in the cells selected during the address period.

In the plasma display apparatus and the method of driving the same according to the embodiment of the present invention, since the falling pulse (i.e., the first pulse) is supplied to the sustain electrode prior to the reset period, the wall charges of the discharge cell are erased more efficiently such that the wall charges remain uniform. Further, the reliability of the driving of the plasma display apparatus is improved by preventing the erroneous discharge. Since the falling pulse is supplied to not the scan electrode and the sustain electrode but the sustain electrode, the falling pulse is supplied to the sustain electrode without a separate voltage source. Accordingly, the driving operation of the plasma display apparatus is simple.

The reset discharge is optimized due to the falling pulse supplied prior to the reset period such that black brightness is lowered and a contrast characteristic is improved.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112(6).

What is claimed is:

1. A method of driving a plasma display apparatus comprising a scan electrode and a sustain electrode, comprising:
supplying a first pulse gradually falling from a reference voltage level to the sustain electrode prior to a reset period.

2. The method of claim 1, wherein a lowest voltage level of the first pulse is substantially equal to a scan voltage.

3. The method of claim 1, wherein a lowest voltage level of the first pulse is substantially equal to a set-down voltage.

4. The method of claim 1, wherein a duration of time for the supplying of the first pulse ranges from 50 um to 150 um.

5. The method of claim 1, wherein the first pulse falls from a ground level voltage to a scan voltage.

6. The method of claim 1, wherein a slope of the first pulse is substantially equal to a slope of a set-down pulse of a reset pulse.

7. The method of claim 1, wherein the supplying of the reference voltage level to the scan electrode occurs during the supplying of the first pulse.

8. A method of driving a plasma display apparatus comprising a scan electrode and a sustain electrode, comprising:
supplying a first pulse falling from a reference voltage level to the sustain electrode prior to a reset period;
maintaining a voltage of the scan electrode at the reference voltage level during the supplying of the first pulse to the sustain electrode; and
supplying a reset pulse to at least one of the scan electrode and the sustain electrode during the reset period.

9. The method of claim 8, wherein the reset pulse comprises a setup pulse and a set-down pulse.

10. The method of claim 9, wherein a voltage difference between the scan electrode and the sustain electrode generates a discharge during the reset period

11. The method of claim 10, wherein after supplying the setup pulse to the scan electrode during the reset period, the set-down pulse is supplied to the scan electrode and a voltage of the sustain electrode is maintained at the reference voltage level.

12. The method of claim 9, wherein a voltage difference between the scan electrode and an address electrode formed to intersect the scan electrode generates a discharge during the reset period.

13. The method of claim 12, wherein after supplying the setup pulse to the scan electrode and the sustain electrode during the reset period, the set-down pulse is supplied to the scan electrode and the sustain electrode during the reset period.

14. The method of claim 8, wherein a duration of time for the supplying of the first pulse ranges from 50 um to 150 um.

15. A plasma display apparatus comprising:
a plasma display panel comprising a scan electrode and a sustain electrode; and
a driver for supplying a first pulse gradually falling from a reference voltage level to the sustain electrode prior to a reset period.

16. The plasma display apparatus of claim 15, wherein a lowest voltage level of the first pulse is substantially equal to a scan voltage or a set-down voltage.

17. The plasma display apparatus of claim 15, wherein a duration of time for the supplying of the first pulse ranges from 50 um to 150 um.

18. The plasma display apparatus of claim 15, wherein the first pulse falls from a ground level voltage to a scan voltage.

19. The plasma display apparatus of claim 15, wherein a slope of the first pulse is substantially equal to a slope of a set-down pulse of a reset pulse.

20. The plasma display apparatus of claim 15, wherein the supplying of the reference voltage level to the scan electrode occurs during the supplying of the first pulse.
